(19) United States
(12) Patent Application Publication
(10) Pub. No.: US 2008/0068332 A1
(43) Pub. Date: Mar. 20, 2008

(54) Optical input device and method of optically sensing user inputs

(76) Inventors: Bernard Lye Hock Chan, Penang (MY); Poh Huat Lye, Penang (MY); Tong Sen Liew, Perak (MY)

Correspondence Address: Kathy Manke;Avago Technologies Limited, 4380 Ziegler Road, Fort Collins, CO, 80525, US

(21) Appl. No.: 11/521,870

(22) Filed: Sep. 15, 2006

(51) Int. Cl. G09G 5/00

(52) U.S. Cl. 345/156

(57) ABSTRACT

An optical input device and method of optically sensing user inputs captures frames of image data using light reflected from an undersurface of a movable pad to estimate movements of the movable pad. Furthermore, the movable pad is automatically returned to an initial position when the movable pad is released.

### BACKGROUND OF THE INVENTION

Conventional input devices, such as joysticks, levers and mechanical computer mice, typically use mechanical components that must physically interact with electrical components to sense user inputs. Due to the physical interactions, the electrical and mechanical components of the input devices are subject to significant amounts of wear and tear during operation. Over time, the wear and tear on the electrical and mechanical components may lead to electrical and mechanical failures, which can cause the input devices to malfunction.

There are input devices that have reduced the issue of wear and tear by using optical imaging techniques to sense user inputs. As an example, an optical computer mouse uses an image sensor array to sequentially capture frames of “images” to sense the relative motion of the mouse with respect to a surface. Thus, the image sensor array essentially replaces the conventional tracking ball and the related electrical and mechanical components to sense the movements of the computer mouse.

One of the disadvantages of optical computer mice, as well as mechanical computer mice, is that the computer mice require a large operating surface on which the mice can be moved. This requirement can be a significant burden when there is limited surface to use, especially for notebook computers. Consequently, many notebook computers now come equipped with touchpads, which do not require a large operating surface. Touchpads operate by sensing the capacitance of a finger to determine its location to allow users to move the finger to control a computer cursor. However, touchpads are subject to wear and tear due to physical interaction between various components of the touchpads.

In view of the above disadvantages, there is a need for an input device that is not subject to wear and tear on sensing components, and does not require a large operating surface.

### SUMMARY OF THE INVENTION

An optical input device and method of optically sensing user inputs captures frames of image data using light reflected from an undersurface of a movable pad to estimate movements of the movable pad. Furthermore, the movable pad is automatically returned to an initial position when the movable pad is released. The design of the optical input device reduces the issue of wear and tear on sensing components of the device and eliminates the need for a large operating surface.

An optical input device in accordance with an embodiment of the invention comprises a movable pad, a light source, an image sensor array, a controller and a self-centering mechanism. The light source is positioned to emit light onto an undersurface of the movable pad. The image sensor array is positioned to receive the light reflected from the undersurface of the movable pad to capture frames of image data. The controller is operably connected to the image sensor array to receive the frames of image data. The controller is configured to process the frames of image data to estimate movements of the movable pad. The self-centering mechanism is operably connected to the movable pad. The self-centering mechanism is configured to support the movable pad such that the movable pad can be displaced. The self-centering mechanism is further configured to automatically return the movable pad to an initial position when the movable pad is released.

A method of optically sensing user inputs in accordance with an embodiment of the invention comprises emitting light onto an undersurface of a movable pad, receiving the light reflected from the undersurface of the movable pad, capturing frames of image data using the received light as the movable pad is displaced, processing the frames of image data to estimate movements of the movable pad, and automatically returning the movable pad back to an initial position when the movable pad is released.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of an optical input device, with a slider pad shown in phantom, in accordance with an embodiment of the invention.

FIG. 2 is a diagram showing a light source, a refracting lens and an optical navigation sensor, which are included in the optical input device of FIG. 1, in accordance with an embodiment of the invention.

FIG. 3 is a top view of a magnetic self-centering mechanism, which can be included in the optical input device of FIG. 1, in accordance with an embodiment of the invention.

FIG. 4 is a perspective view of the magnetic self-centering mechanism.

FIG. 5 is a flow diagram of a method of optically sensing user inputs in accordance with an embodiment of the invention.

### DETAILED DESCRIPTION

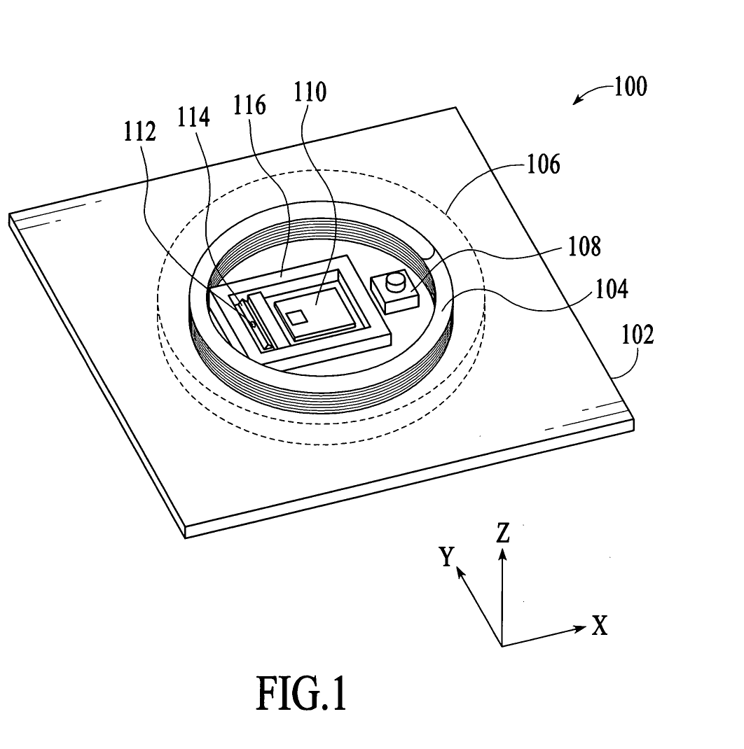

With reference to FIG. 1, an optical input device 100 in accordance with an embodiment of the invention is shown. The optical input device 100 can be used to control movements of a subject, such as a cursor on a computer screen or a robotic arm. As described in more detail below, the optical input device 100 is designed to reduce physical interactions between electrical and mechanical components of the device. As a result, most components of the optical input device 100 are not subject to wear and tear, which can degrade the performance of the device or cause the device to malfunction. Furthermore, the optical input device 100 does not require a large operating surface as conventional input devices, such as optical computer mice.

As shown in FIG. 1, the optical input device 100 comprises a substrate 102, a self-centering mechanism 104, a slider pad 106 (shown in phantom in FIG. 1), a microswitch 108, an optical navigation sensor 110, a light source 112 and a refracting lens 114. The substrate 102 provides support for the other components of the optical input device 100. In this embodiment, the substrate 102 is a printed circuit board (PCB). However, in other embodiments, the substrate 102 may be any type of substrate that can support the other components of the optical input device 100. The self-centering mechanism 104 is attached to the upper surface of the substrate 102, and thus, is positioned over the substrate. The self-centering mechanism 104 supports the slider pad 106, which is positioned on and attached to the self-centering mechanism. Thus, the slider pad 106 is structurally connected to the substrate 102 via the self-centering mechanism 104.

The self-centering mechanism 104 is configured to be displaced or moved laterally along any X-Y direction when lateral force is applied. Consequently, when a user places a finger or a thumb on the upper surface of the slider pad 106 and applies a force along a X-Y direction, the slider pad is allowed to be displaced in the corresponding lateral direction by the self-centering mechanism 104. Furthermore, the self-centering mechanism 104 is configured to be displaced vertically in the Z direction when vertical force is applied. Consequently, when a user places a finger or thumb on the upper surface of the slider pad 106 and applies a downward pressure along the Z direction, the slider pad is allowed to be displaced in the corresponding vertical direction, i.e., the downward direction, by the self-centering mechanism 104. The self-centering mechanism 104 is also configured to return to its initial lateral and vertical position when no external force is applied. Consequently, when a user releases the slider pad 106, the slider pad is automatically returned back to its initial position by the self-centering mechanism 104. In the illustrated embodiment, the slider pad 106 is a thin circular member. However, in other embodiments, the slider pad 106 can be of any shape.

In the embodiment shown in FIG. 1, the self-centering mechanism 104 is a spring, which allows the slider pad 106 to be displaced laterally along any X-Y direction and displaced vertically along the Z direction. The self-centering spring 104 may be made of metal or other suitable material. The self-centering spring 104 may be selected to have a particular tension so the slider pad 106 will have a desired tactile response.

The light source 112, the optical navigation sensor 110 and the microswitch 108 are mounted on the substrate 102, and thus, are positioned over the substrate. If the substrate 102 is a PCB, the light source 112, the optical navigation sensor 110 and the microswitch 108 are electrically connected to the substrate to transmit and/or receive electrical signals to and/or from the substrate. In the embodiment shown in FIG. 1, the light source 112, the optical navigation sensor 110 and the microswitch 108 are located inside the self-centering spring 104. However, in other embodiments, one or more of these components may be located outside of the self-centering spring 104. As shown in FIG. 1, the optical navigation sensor 110 is separated from the light source 112 and the refracting lens by a housing structure 116. The light source 112 and the optical navigation sensor 110 operate together to track the lateral movements of the slider pad 106 along any X-Y direction. The microswitch 108 operates to detect user inputs in the form of presses on the slider pads 106. The microswitch 108 is activated when the slider pad 106 is pushed downward to depress a button on the microswitch 108. As an example, the microswitch 108 may serve a similar function as a conventional computer mouse button.

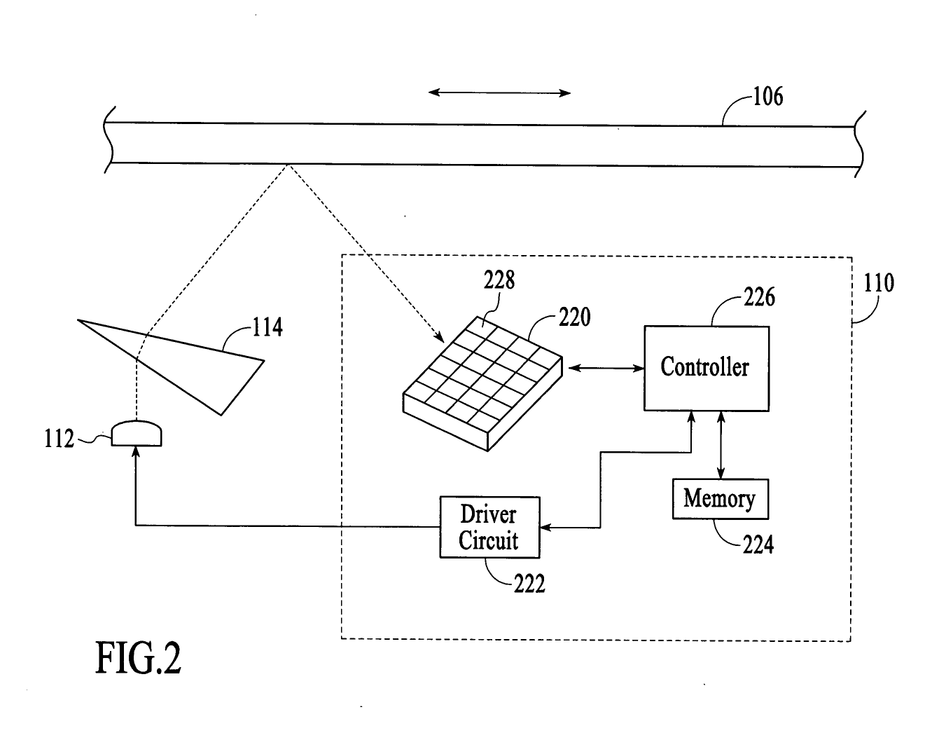

The optical navigation sensor 110 is an integrated circuit (IC) device, which includes several components. In this embodiment, as illustrated in FIG. 2, the optical navigation sensor 110 is an IC device that includes at least an image sensor array 220, a driver circuit 222, memory 224 and a controller 226. In other embodiments, the optical navigation sensor 110 may be separated into multiple electrical units, each of which includes one or more of the components of the optical navigation sensor, including the image sensor array 220, the driver circuit 222, the memory 224 and the controller 226.

The light source 112 provides illumination to a target area on the undersurface of the slider pad 106 that is to be imaged. The location of the illuminated target area of the slider pad 106 changes when the slider pad is laterally displaced. The light source 112 may be a light emitting diode, a laser diode or any other light emitting device. The light source 112 is activated by the driver circuit 222, which provides driving signals to the light source. The refracting lens 114 is used to focus the light from the light source 112 onto the undersurface of the slider pad 106. The image sensor array 220 operates to electronically capture reflected light from the undersurface of the slider pad 106 as frames of image data. The image sensor array 220 includes photosensitive pixel elements 228 that generate image signals in response to light incident on the elements. As an example, the image sensor array 220 may be a charged-coupled device (CCD) image sensor array or a complementary metal oxide semiconductor (CMOS) image sensor array. The number of photosensitive pixel elements 228 included in the image sensor array 220 may vary depending on at least performance requirements with respect to optical tracking of the slider pad 106. As an example, the image sensor array 220 may include 30×30 array of active photosensitive pixel elements 228.

The controller 226 is configured to control the driver circuit 222 and the image sensor array 220 in order to sequentially capture frames of image data of the target undersurface. The controller 226 is electrically connected to the driver circuit 222 and the image sensor array 220 to provide control signals. The controller 226 provides control signals to the driver circuit 222 to direct the driver circuit to apply driving signals to the light source 112 to activate the light source. The controller 226 also provides control signals to the image sensor array 220 to direct the image sensor array to accumulate electrical charges at the photosensitive pixel elements 228 to capture each frame of the target undersurface of the slider pad 106. Thus, the controller 226 is able to control the frame rate of the image sensor array 220. The controller 226 is also configured to process the captured frames to estimate movements or displacements of the slider pad 106. These estimates can then be used to control a subject, such as a cursor on a computer screen or a robotic arm.

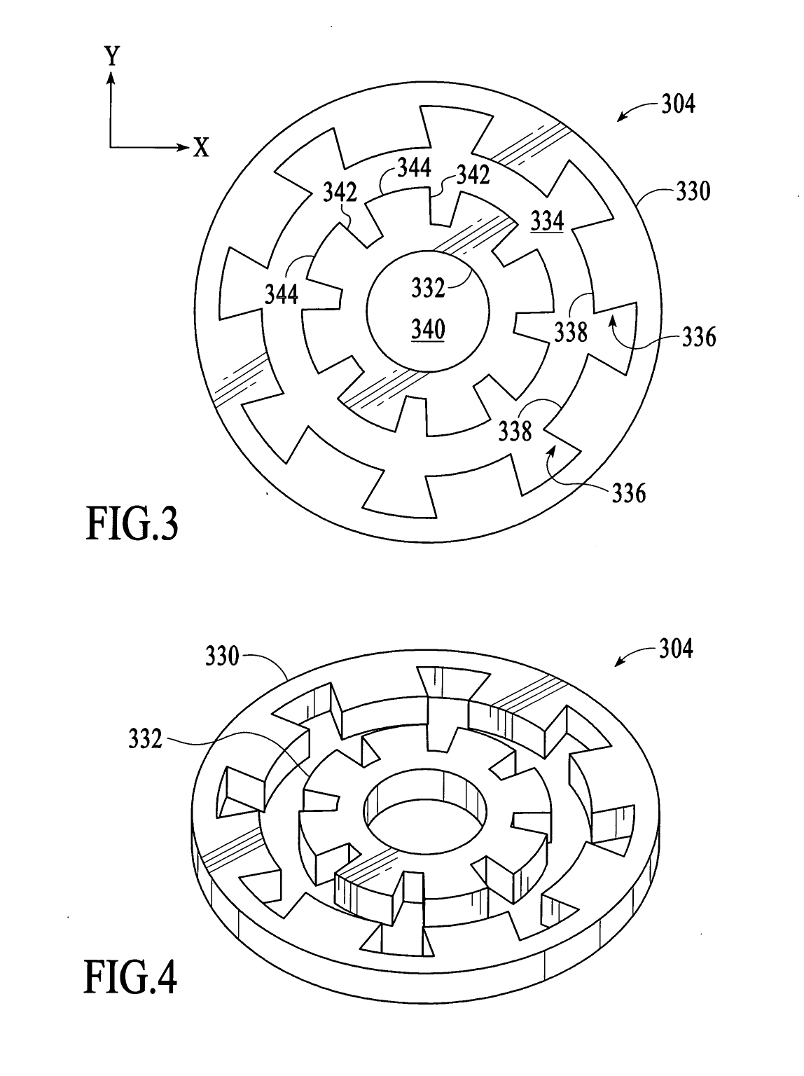

Turing now to FIGS. 3 and 4, a magnetic self-centering mechanism 304 in accordance with an embodiment of the invention is shown. FIG. 3 is a top view of the magnetic self-centering mechanism 304, while FIG. 4 is a perspective view of the magnetic self-centering mechanism. The magnetic self-centering mechanism 304 is designed to replace the self-centering spring 104 in the optical input device 100. As described in more detail below, the magnetic self-centering mechanism 304 uses magnetic force, in particular, magnetic repulsive force, to return the slider pad 106 back to its initial position when the slider pad is released.

As shown in FIG. 3, the magnetic self-centering mechanism includes a stationary member 330 and a movable member 332, which both have magnetic properties. The stationary member 330 is attached to the upper surface of the substrate 102 of the optical input device 100, and is designed to not move. The stationary member 330 includes a central opening 334, which is large enough to accommodate the movable member 332 with sufficient additional space for the movable member to be displaced laterally in any X-Y direction. In the illustrated embodiment, the stationary member 330 is configured in a toroid-like shape with flat upper and lower surfaces, as best shown in FIG. 4. However, in other embodiments, the stationary member 330 can be configured in any shape having the central opening 334, which may or may not be circular in shape. The stationary member 330 includes magnetic portions 336 with magnetic surfaces 338, which all have a common magnetic pole, i.e., north or south pole. The particular magnetic pole of the magnetic surfaces 338 may be caused by permanent magnets or electromagnets. The magnetic portions 336 are located at the inner perimeter of the stationary member 330 such that the magnetic surfaces 338 face toward the center region of the central opening 334. In the illustrated embodiment, the magnetic portions 336 of the stationary member 330 are configured to protrude toward the center of the stationary member. However, in other embodiments, the magnetic portions 336 of the stationary member 330 may be configured to not protrude or not protrude in such a manner.

The movable member 332 of the magnetic self-centering mechanism 304 is positioned in the central opening 334 of the stationary member 330. The movable member 332 is also attached to the slider pad 106 of the optical input device 100, and is free to be displaced within the central opening 334 of the stationary member 330. Similar to the stationary member 330, the movable member 332 includes a central opening 340, which is large enough to accommodate the light source 112, the refracting lens 114, the optical navigation sensor 110 and the microswitch 108 of the optical input device 100 with sufficient space for the movable member to be displaced during operation. In the illustrated embodiment, similar to the stationary member 330, the movable member 332 is configured in a toroid-like shape with flat upper and lower surfaces, as best shown in FIG. 4. However, in other embodiments, the stationary member 332 can be configured in any shape having the central opening 340, which may or may not be circular in shape. The movable member 332 includes magnetic portions 342 with magnetic surfaces 344, which all have the same magnetic pole, i.e., north or south pole, as the magnetic surfaces 338 of the stationary member 330. The magnetic portions are located at the outer perimeter of the movable member 332 such that the magnetic surfaces 344 face outward toward the magnetic surfaces 338 of the stationary member 330. In the illustrated embodiment, the magnetic portions 342 of the movable member 332 are configured to protrude outward away from the center region of the movable member. However, in other embodiments, the magnetic portions 342 of the movable member 332 may be configured to not protrude or not protrude in such a manner.

Since the magnetic surfaces 338 of the stationary member 330 and the magnetic surfaces 344 of the movable member 332 face each other, there is repulsive magnetic force between the stationary member and the movable member. Thus, when the movable member 332 is displaced from the center of the stationary member 330 and then released, the repulsive magnetic force pushes the movable member back to the center of the stationary member. Since the slider pad 106 is attached to the movable member 332, the slider pad is always returned to its initial position when released by the magnetic self-centering mechanism 304.

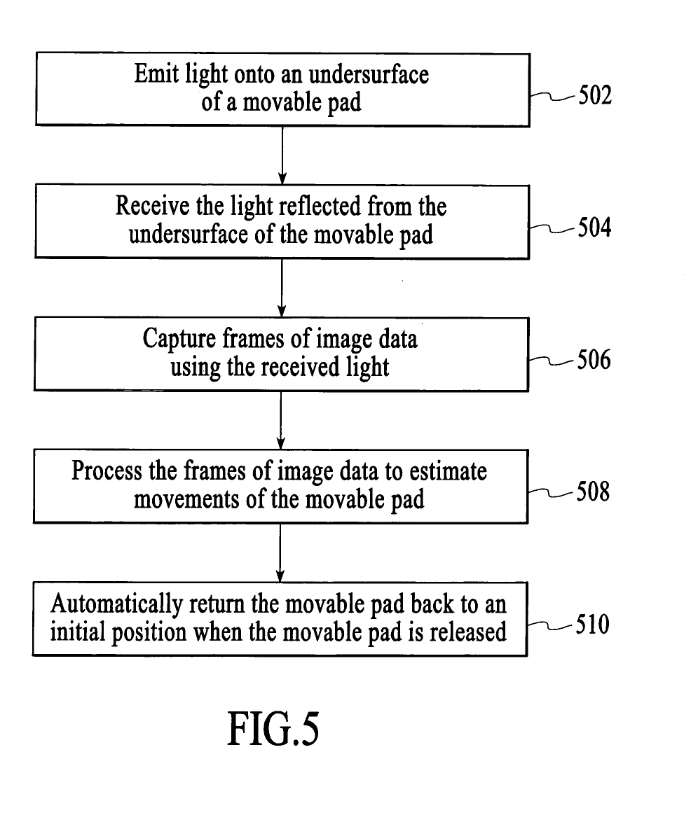

A method of optically sensing user inputs in accordance with an embodiment of the invention is described with reference to FIG. 5. At block 502, light is emitted onto an undersurface of a movable pad, such as a slider pad of an optical input device. The light may be emitted from a light source of the optical input device, which may be a light emitting diode or a laser diode. Next, at block 504, the light reflected from the undersurface of the movable pad is received. The reflected light may be received at an image sensor array of the optical input device. Next, at block 506, frames of image data are captured using the received light as the movable pad is displaced. These frames of image data may be captured by the image sensor array. Next, at block 508, the frames of image data are processed to estimate movements of the movable pad. The frames of image data may be processed by a controller of the optical input device. Next, at block 510, the movable pad is automatically returned back to an initial position when the movable pad is released. The movable pad may be automatically returned using a self-centering spring or a magnetic self-centering mechanism.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An optical input device comprising:
a movable pad;
a light source positioned to emit light onto an undersurface of said movable pad;
an image sensor array positioned to receive said light reflected from said undersurface of said movable pad to capture frames of image data; and
a controller operably connected to said image sensor array to receive said frames of image data, said controller being configured to process said frames of image data to estimate movements of said movable pad; and
a self-centering mechanism operably connected to said movable pad, said self-centering mechanism being configured to support said movable pad such that said movable pad can be displaced, said self-centering mechanism being further configured to automatically return said movable pad to an initial position when said movable pad is released.

2. The device of claim 1 wherein said self-centering mechanism includes a spring attached to said movable pad.

3. The device of claim 1 wherein said self-centering mechanism includes a stationary member attached to a substrate and a movable member attached to said movable pad, said stationary member and said movable member having magnetic properties.

4. The device of claim 3 wherein said substrate is a printed circuit board, said light source, said image sensor array and said controller being positioned over said printed circuit board.

5. The device of claim 3 wherein said stationary member includes a central opening and wherein said movable member is positioned in said central opening.

6. The device of claim 5 wherein at least one of said stationary member and said movable member is configured in a toroid-like shape.

7. The device of claim 5 wherein said stationary member includes first magnetic surfaces at an inner perimeter of said central opening and wherein said movable member includes second magnetic surfaces at an outer perimeter of said movable member.

8. The device of claim 1 further comprising a microswitch positioned to be activated by said movable member when a downward pressure is applied to an upper surface of said movable pad.

9. The device of claim 1 further comprising a substrate, said light source, said image sensor array and said controller being positioned over said substrate.

10. The device of claim 9 wherein said substrate is a printed circuit board.

11. The device of claim 1 wherein said light source is a light emitting diode or a laser diode.

12. The device of claim 1 wherein said image sensor array and said controller are part of an integrated circuit device.

13. A method of optically sensing user inputs, said method comprising;
emitting light onto an undersurface of a movable pad;
receiving said light reflected from said undersurface of said movable pad;
capturing frames of image data using said received light as said movable pad is displaced;
processing said frames of image data to estimate movements of said movable pad; and
automatically returning said movable pad back to an initial position when said movable pad is released.

14. The method of claim 13 wherein said automatically returning said movable pad includes utilizing a spring to return said movable pad back to said initial position when said movable pad is released.

15. The method of claim 13 wherein said automatically returning said movable pad includes utilizing magnetic force to return said movable pad back to said initial position when said movable pad is released.

16. The method of claim 15 wherein said utilizing said magnetic force includes utilizing repulsive magnetic force to return said movable pad back to said initial position when said movable pad is released.

17. The method of claim 13 further comprising electrically sensing a downward pressure applied on an upper surface of said movable pad.

18. The method of claim 17 wherein said electrically sensing includes utilizing a microswitch to sense said downward pressure applied on said upper surface of said movable pad.

19. The method of claim 13 wherein said emitting said light includes emitting said light from a light emitting diode or a laser diode.

20. The method of claim 13 wherein said capturing and said processing are performed utilizing an integrated circuit device that includes at least an image sensor array and a controller.
